(19) United States
(12) Patent Application Publication
(10) Pub. No.: US 2017/0236220 A1
(43) Pub. Date: Aug. 17, 2017

(54) Linear and gradual tax rate system for tax software products

(71) Applicants: John H. Lee, Olathe, KS (US); Richard A. Lee, Olathe, KS (US)

(72) Inventors: John H. Lee, Olathe, KS (US); Richard A. Lee, Olathe, KS (US)

(73) Assignee: Rigel Technology Corporation, Olathe, KS (US)

(21) Appl. No.: 15/044,276

(22) Filed: Feb. 16, 2016

(51) Int. Cl. G06Q 40/00; G06Q 50/26

(52) U.S. Cl. CPC G06Q 40/123; G06Q 50/26

(57) ABSTRACT

The present invention provides a linear and gradual (LG) tax rate system with a tax processor for tax software products. Existing two tax systems of federal individual Tax Schedules and Tax Table/Tax Computation Worksheet are simplified and combined into one LG tax rate system. The tax processor and software product are designed for taxpayers (employees, employers or self-employments) to file tax returns, for employers to do payroll to employees and transfer withholding taxes to governments or for governments to inspect tax returns by comparing tax withholding reports and tax returns according to related standards instead of existing random selections. Differences of taxes, tax rates and taxable incomes are set at low, mid and high levels for tax return options, quick tax refunds, regular inspections and detail audits to reduce tax returns and potential tax crimes and save tax processing time and costs (billions) for businesses, individuals and governments.

### U.S. PATENT DOCUMENTS

| | | | |
|---|---|---|---|
| 9,064,285 | Jun. 23, 2015 | Nathoo | 1/1 |
| 8,788,412 | Jul. 22, 2014 | Hamm | 705/39 |
| 8,694,394 | Apr. 8, 2014 | Bross, et al. | 705/31 |
| 8,682,766 | Mar. 25, 2014 | Blowers | 705/31 |
| 8,612,318 | Dec. 17, 2013 | Blowers | 705/31 |
| 8,165,936 | Apr. 24, 2012 | Chen | 705/31 |
| 8,099,342 | Jan. 17, 2012 | Christian, et al. | 705/31 |
| 8,099,329 | Jan. 17, 2012 | Paulsen, et al. | 705/19 |
| 8,082,144 | Dec. 20, 2011 | Brown, et al. | 704/9 |
| 7,966,231 | Jun. 21, 2011 | Foster | 705/31 |
| 7,610,226 | Oct. 27, 2009 | Miller | 705/31 |
| 7,539,635 | May 26, 2009 | Peak, et al. | 705/31 |
| 6,993,502 | Jan. 31, 2006 | Gryglewicz, et al. | 705/31 |
| 4,324,975 | Apr. 13, 1982 | Rees | 235/70A |

### FIELD OF THE INVENTION

The present invention provides a linear and gradual (LG) tax rate system with a tax processor for tax software products. With the linear and gradual (LG) tax rate system, the tax processor is designed to figure out related tax rates and taxes by inputting taxable incomes or incomes with considering deductions, retirements, credits and others. Then a tax software product is further designed and used for (1) a payroll system for employers to pay employees, (2) a tax inspection system for governments to inspect tax returns according to related standards by comparing differences between tax withholding reports and tax returns instead of existing random selections or (3) a tax return system for taxpayers (employees, employers or self-employments) to prepare tax returns.

### BACKGROUND OF THE INVENTION

Marginal tax systems are used for tax systems in the U.S. and many other countries. Existing U.S. federal and state tax systems for individuals and businesses are based on their marginal tax systems. A marginal tax rate is a percent tax rate, which is a flat tax rate, during a tax bracket. Many tax brackets are needed for smooth tax rate changes. For a practical purpose, several tax brackets are usually used. 2013-2016 U.S. federal personal tax systems have 7 tax brackets. U.S. federal personal tax brackets have been changed over time from 25 tax brackets in 1970 to 16 tax brackets in 1980, to 5 tax brackets in 2000 and to 6 tax brackets in 2012, which make our tax systems more changeable and complex. Tax systems with more tax brackets have smoother tax rate changes, but they are more complex and take more time and costs to calculate, process, analyze, modify, project and reform. Flat tax rates are too simple, which can not cover different incomes reasonably with relatively high tax rates to low incomes and relatively low tax rates to high incomes. Personal income tax systems involve different filling statuses, which are more complex than business tax systems. Marginal tax systems are difficult to be reformed easily and reasonably. From the existing federal tax systems, tax fraud crimes have significant challenge, which cost the IRS some $5.2 billion in 2013.

There are two tax systems in the existing U.S. federal personal tax system with the four filling statuses. One tax system is Tax Rate Schedules (including related tax withholding tables for different filing periods), which are used for employers to estimate employees' income taxes. Another tax system includes Tax Table and Tax Computation Worksheet, which are used for employees to calculate income taxes for filling tax returns. The two tax systems, which have similar tax rates, require all employees to collect their estimated taxes and file tax returns. Table 1 shows 2015 Tax Rate Schedules. Table 2 shows partial 2014 Tax Table (12 pages). Table 3 shows partial 2015 and 2014 tax computations, which have slight changes of taxable income ranges and math formulas. There are about 138 million federal tax returns in 2013 with significant tax processing time and costs.

The publication time difference between Tax Rate Schedules and Tax Table/Tax Computation Worksheet is about one year and two months apart. For example, 2015 Tax Rate Schedules with the 7 tax brackets and tax rate ranges 15%-39.6% are published in December, 2014, which are used for employers to estimate employees' income taxes for 2015 withholding taxes. The number $29,387.5 (*) in Table 1 is from 18450*10%+(74900-18450)*15%+(151200-74900)*25%=1845+8467.5+19075=29387.5. The number $129,996.5 (*) is from $111,324+(464850-411500)*35%. 2015 Tax Table and Tax Computation Worksheet are published in January, 2016, are used for employees to calculate their income taxes for filing tax returns by Apr. 15, 2016. Comparing 2015 with 2014 and 2013, their Tax Rate Schedules, Tax Table (cover taxable incomes not over $100,000) and Tax Computation Worksheet have slight changes each year even though they have the same 7 tax brackets, tax rate ranges 10%-39.6% and Tax Table (12 pages). Taxable income ranges are usually changed from 10 to 2,500. Tax Computation Worksheet is also changed, which affects progressive taxes and tax rates. Some changes are very slight such as tax rates at taxable income $100,000 for Married Filing Jointly are changed from 16.7% in 2014 to 16.6% in 2015 and 16.5% in 2016. There are also changes for related tables and data changes over different filing periods on such as bi-weekly, monthly, quarterly or semi-yearly basis. All changes, even very slight changes, make our tax systems complex, which increase tax processing time and costs.

TABLE 1
Federal Individual Tax Rate Schedules (2015) for Income Tax Estimation

| | | | |
|---|---|---|---|
| Taxable income (TI) | | | |
| Over Not over | Tax is | The Amount is over | Tax Computation |

Schedule Y 1 - Married Filing Jointly or Qualifying Widow(er)

| | | | |
|---|---|---|---|
| 0-18,450 | 10% | 0 | 0.1 * TI |
| 18,450-74,900 | $1,845 + 15% | $18,450 | 1,845 + 0.15 * (TI − 18,450) |
| 74,900-151,200 | $10,312.50 + 25% | 74,900 | 10,312.50 + 0.25 * (TI − 74,900) |
| 151,200-230,450 | * $29,387.50 + 28% | 151,200 | 29,387.50 + 0.28 * (TI − 151,200) |
| 230,450-411,500 | $51,577.50 + 33% | 230,450 | 51,577.50 + 0.33 * (TI − 230,450) |
| 411,500-464,850 | $111,324.00 + 35% | 411,500 | 111,324.00 + 0.35 * (TI − 411,500) |
| 464,850 | * $129,996.50 + 39.6% | 464,850 | 129,996.50 + 0.396 * (TI − 464,850) |

Schedule Z - Head of Household

| | | | |
|---|---|---|---|
| 0-13,150 | 10% | 0 | 0.1 * TI |
| 13,150-50,200 | $1,315.00 + 15% | $13,150 | 1,315 + 0.15 * (TI − 13,150) |
| 50,200-129,600 | $6,872.50 + 25% | 50,200 | 6,872.5 + 0.25 * (TI − 50,200) |
| 129,600-209,850 | $26,722.5 + 28% | 129,600 | 26,722.5 + 0.28 * (TI − 129,600) |
| 209,850-411,500 | $49,192.5 + 33% | 209,850 | 49,192.5 + 0.33 * (TI − 209,850) |
| 411,500-439,000 | $115,737 + 35% | 411,500 | 115,737 + 0.35 * (TI − 411,500) |
| 439,000 | $125,362 + 39.6% | 439,000 | 125.362 + 0.396 * (TI − 439,000) |

Schedule X - Single

| | | | |
|---|---|---|---|
| 0-9,225 | 10% | 0 | 0.1 * TI |
| 9,225-37,450 | $922.50 + 15% | $9,225 | 892.50 + 0.15 * (TI − 9,225) |
| 37,450-90,750 | $5,156.25 + 25% | 37,450 | 4,991.25 + 0.25 * (TI − 37,450) |
| 90,750-189,300 | $18,481.25 + 28% | 90,750 | 17,891.25 + 0.28 * (TI − 90,750) |
| 189,300-411,500 | $46,075.25 + 33% | 189,300 | 44,603.25 + 0.33 * (TI − 189,300) |
| 411,500-413,200 | $119,401.25 + 35% | 411,500 | 115,586.25 + 0.35 * (TI − 411,500) |
| 413,200 | $119,996.25 + 39.6% | 413,200 | 116,163.75 + 0.396 * (TI − 413,200) |

Schedule Y 2 - Married Filing Separately

| | | | |
|---|---|---|---|
| 0-9,225 | 10% | 0 | 0.1 * TI |
| 9,225-37,450 | $922.50 + 15% | $9,225 | 922.50 + 0.15 * (TI − 9,225) |
| 37,450-75,600 | $5,156.25 + 25% | 37,450 | 5,156.25 + 0.25 * (TI − 37,450) |
| 75,600-115,225 | $14,693.75 + 28% | 75,600 | 14,693.75 + 0.28 * (TI − 75,600) |
| 115,225-205,750 | $25,788.75 + 33% | 115,225 | 25,788.75 + 0.33 * (TI − 115,225) |
| 205,750-232,425 | $55,662.00 + 35% | 205,750 | 55,662.00 + 0.35 * (TI − 205,750) |
| 232,425 | $64.998.25 + 39.6% | 232,425 | 64.998.25 + 0.396 * (TI − 232,425) |

Based on the two federal income tax systems of early tax estimations from Tax Rate Schedules and later tax calculations for tax returns from Tax Table and Tax Computation Worksheet, payroll, withholding tax and tax return software products are designed and used. For Tax Table as an example, related computer software products need to cover many tax numbers in Tax Table with more data space. For example, the 2014 Tax Table has about 10,832 tax numbers (42*4*4+60*4*10*4+60*2*4+20*4) from the 12-page Tax Table (2014). Even though there are many independent tax numbers in the Tax Table, their tax rates are still flat during their tax brackets. Table 2 has 28 tax numbers (7*4). More flat tax rates have smoother tax rate changes. But they are more complex and take more time and costs for tax search, calculation, analysis, reform and projection. Many states have similar marginal tax systems. Hawaii has 12 tax brackets for its personal tax system with 3 tax filing statuses, which are very complex. California has 10 tax brackets in its personal tax system, which is also very complex. Ohio, Missouri or Iowa have 9, 10 or 9 tax brackets respectively. Kansas has 2 tax brackets with flat and curve tax rates and Tax Table with about 4,000 tax numbers (11*6*2*4*7+38*2*4) from 2015 Tax Table (8 pages). They need to be simplified with smooth tax rate changes and less tax brackets.

TABLE 2
Partial 2015 Federal Tax Table (12 pages) Check again

| Taxable income (TI) | | 2014 Tax | | | |
|---|---|---|---|---|---|
| Over | Not over | Y-1 | Z | X | Y-2 |
| 0 | 5 | 0 | 0 | 0 | 0 |
| 5 | 15 | 1 | 1 | 1 | 1 |
| 50 | 75 | 6 | 6 | 6 | 6 |
| 1,000 | 1,025 | 101 | 101 | 101 | 101 |
| 10,000 | 10,050 | 1003 | 1003 | 1043 | 1043 |
| 50,000 | 50,050 | 6581 | 6846 | 8300 | 8300 |
| 99,950 | 100,000 | 16581 | 19316 | 21064 | 21519 |

TABLE 3
Tax Computations for Married Filing Jointly or Qualifying Widow(er)

| Taxable income (TI) | | | Taxable income (TI) | | |
|---|---|---|---|---|---|
| Over | Not over | 2014 Tax | Over | Not over | 2015 Tax |
| 0 | 100,000 | Tax Table (12 pages) | 0 | 100,000 | Tax Table (12 pages) |
| 100,000 | 148,850 | 0.25 * TI − 8,287.5 | 100,000 | 151,200 | 0.25 * TI − 8,412.5 |
| 148,850 | 226,850 | 0.28 * TI − 12,753 | 151,200 | 230,450 | 0.28 * TI − 12,948.5 |
| 226,850 | 405,100 | 0.33 * TI − 24,095.5 | 230,450 | 411,500 | 0.33 * TI − 24,471 |
| 405,100 | 457,600 | 0.35 * TI − 32,197.5 | 411,500 | 464,850 | 0.35 * TI − 32,701 |
| 457,600 | | 0.396 * TI − 53,247 | 464,850 | | 0.396 * TI − 54,084 |

Besides many tax numbers in these tax tables for taxpayers to file tax returns such as 10,832 tax numbers in 2014 federal Tax Table (12 pages), another complex area is tax withholding tables on different filing periods for employers to estimate withholding income taxes. Kansas has 22-page tax withholding tables with many numbers based on the two tax filing statuses and different filing period of weekly, bi-weekly, semi-monthly, monthly or quarterly basis, which are complex for employers to use to file KS withholding taxes. Missouri tax system is simple with the same Tax Chart for different tax filing statuses, which means there is no difference between different tax filing statuses. Missouri tax withholding tables are 10 pages long, which is still complex for employers to estimate withholding income taxes. The federal IRS has complex tax withholding tables with at least 40 pages with many numbers based on the different tax filing statuses and filing period of weekly, bi-weekly, semi-monthly, monthly or quarterly basis. Marginal tax systems are used in the U.S. federal and many state tax systems. One or few flat tax rates, which are too simple, can not cover different taxable incomes reasonably. Many other countries also usually use marginal tax systems and have similar issues and challenges, which are difficult to be reformed with changing taxable income ranges, tax numbers in tax tables, computations and brackets in complex formats.

For developing tax/payroll systems, methods and software products, various attempts have been made over the years. U.S. Pat. No. 9,064,285 discloses a payroll service to obtain employee information from the payroll service for adding a new employee. U.S. Pat. No. 8,788,412 discloses a system and method for processing transaction and tax data, verifying tax calculations/determinations, reconciling calculation/determination errors, and filing and/or paying taxes. U.S. Pat. No. 8,694,394 is directed to a computer-based method performed in a first transaction-tax-related application, which comprises exchanging transaction-related data. U.S. Pat. No. 8,682,766 discloses a method for providing a set of automated financial services to a set of clients. The set of automated financial services include payroll processing, trust fund management, investment of funds and ACH transactions processing. U.S. Pat. No. 8,612,318 discloses a method and system for payroll tax settlement that receives payroll tax files from a payroll provider system. U.S. Pat. No. 8,165,936 discloses a payroll system and method for generating, accumulating and reporting on payroll information. U.S. Pat. No. 8,099,342 discloses the methods, apparatus, and articles of manufacture for tax computation, management, and compliance reporting via a centralized transactional tax platform. U.S. Pat. No. 8,099,329 discloses the systems and methods for determining taxes owed for financial transactions conducted over a network. U.S. Pat. No. 8,082,144 discloses a tax calculation explanation generator. U.S. Pat. No. 7,966,231 discloses a method and system for determining taxes attributable to a financial transaction to create a tax rate table. U.S. Pat. No. 7,610,226 provides a system for tax data collection from the tax data provider to connect electronically with a taxing authority, file the electronic tax return with the taxing authority, and arrange electronically for the payment or receipt of any tax liability or refund, respectively. U.S. Pat. No. 7,539,635 discloses a system and method for generating personalized tax device documents. U.S. Pat. No. 6,993,502 discloses a system and method for computing and collecting taxes, which has applications for determining taxes for transactions conducted over the Internet. U.S. Pat. No. 4,324,975 discloses a tax calculator for calculating Federal Income Taxes.

Besides the U.S., many other countries also use marginal tax systems with multi tax brackets for income tax systems. Multi or many tax brackets are needed for smooth tax rate changes. But more tax brackets make tax systems more complex and difficult to be operated and reformed, which need more tax processing time and costs. China has 7 tax brackets (tax rates: 3-45%) for its income tax system currently. Japan has 6 tax brackets (tax rates: 5-40%). Germany has 4 tax brackets (tax rates: 0-45%) for its income tax system. Canada has 4 tax brackets (tax rates: 15-29%). New Zealand has 4 tax brackets (tax rates: 10.5-33%). United Kingdom 3 tax brackets (tax rates: 20-45%). Tax brackets and tax rates are often changed in national and local tax systems over time such as New Zealand had 7 tax brackets (tax rates: 15-39%) in 2008 and China had 9 tax brackets (tax rates: 5-45%) in 2007. More tax brackets mean more smooth tax rate changes, which are more reasonable for different taxable incomes and involve more time and costs. Less tax brackets mean non-smooth tax rate changes with a marginal tax system.

### SUMMARY OF THE INVENTION

This invention discloses a linear and gradual (LG) tax rate system with a tax processor, which is designed to figure out related tax rate and tax by inputting a taxable income and tax filing status. A taxable income is from its income after deducting deductions, retirements, costs, credits and others. There is one or more tax filing statuses. A LG tax rate formula is picked for tax rate and tax calculations by the tax processor. The tax processor from taxable income (or income) to income tax is done automatically. The LG tax rate system includes two or more taxable income ranges with preferred from 2 to 6, related tax rate ranges, simple tax rate formulas with a+TI/b or c−d/TI (TI is taxable income and a, b, c and d are constants) for calculating tax rate and income tax. Taxable income ranges and tax rate ranges are less and reasonable as possible to have fair tax rates for all taxable income ranges. When taxable income ranges or tax rate ranges are 7 and more, a tax system is complex. With the linear and gradual (LG) tax rate system and the tax processor, a tax software (including computer program) product is further designed for different purposes. The tax processor is independent or is a part of a tax software product. An independent tax software product is usually complex and independent. A computer program is usually not complex software product, which is independent or is based on an existing software product with modifications for tax purposes.

The LG tax rate system simplifies the existing two federal personal tax systems (Tables 1, 2 and 3), which are used by employers to estimate withholding income taxes and by employees to calculate taxes for tax returns separately, into one simple system. Existing 7 tax brackets are reduced to 4 or 3 with a 43% or more reduction, which is shown in Table 4. The one simple LG tax rate system, which is simple without many tax numbers (such as 10,832 from 2014 federal Tax Table) and multi-page withholding tables (such as 22 pages from KS withholding tables), can be used by all parties. Then income taxes can be used for different tax systems of tax returns, payroll payments, withholding taxes and yearly withholding tax reports reasonably according to the LG tax rate system. Related tax software (including computer program) products for employers to use the payroll system, for governments to use the inspection tax system and for taxpayers to file tax returns can be designed for related applications. The LG tax rate system can be also involved into an accounting software product. From the tax software products, governments or taxpayers can decide their next actions for further auditing tax returns or filing tax returns or not. The existing two federal personal tax systems of Tax Rate Schedules and Tax Table and Tax Computation Worksheet in 2015 are simplified and combined with the LG tax rate system, which are shown in Table 4. Their tax rate differences are very minor differences when TI>$500, which are shown in Table 5.

We have designed a tax return software product according to the LG tax rate system with the tax processor for tax preparations and tax returns for employees and self-employments. When an employee receives his or her tax report with tax data such as withholding taxes (federal and state), filing status, exemptions, retirement, adjustable gross incomes (AGI), taxable income, tax rate, income tax, credit, name, social security number and address, he or she may use the tax return software product to prepare tax return to figure out income tax according to gross income, deductions, exemption, retirements, credits and others automatically. A filing status is selected and an income (or taxable income) is inputted, the tax return software product picks related tax filing status and tax rate formula and calculates its tax rate and income tax automatically. Table 4 or similar tables may also be used for manual calculations. When tax differences comparing tax return calculations with total income taxes from tax reports are less than a low level such as $200 or $100, these taxpayers may have an option to not file tax returns and let governments to know because it may not cover tax processing costs. Then many tax returns could be reduced for saving time and costs from this option. The tax differences at the low level need to be regulated by governments, which may combine with taxable incomes less than $100,000 (or AGI<$120,000). The tax differences need to cover tax processing costs at least. Many employees have non-complex tax situations with standard reductions and credits for their withholding taxes by their employers. There are about 138 million federal taxpayers in the U.S. with reported earnings of $9.03 trillion in AGI and paid $1.23 trillion in income taxes in 2013. The top 50% of all taxpayers paid about 97.2% of all income taxes. The bottom 50% paid the remaining 2.8% with an average income tax $499. During the 138 million federal tax returns, 90% of the tax returns have AGI less than $127,695 and 75% of the tax returns have AGI less than $74,955.

TABLE 4
LG Tax Rate System for Federal Individual Tax Return (2015)
(1) Married Filing Jointly or widow(er) (MFJ), (2) Head of Household,
(HH) (3) Single (S), and (4) Married Filing Separately (MFS)

| Filing | Taxable Income (TI) | | Your | | Tax | Range | Tax |
|---|---|---|---|---|---|---|---|
| Status | Over | Not over | TI | LG tax rate formula | rate | check | TI*rate |
| 11 | 0 | 100,000 | | 0.1 + TI*F/1,515,151.5 | | 0.1-0.166 | |
| 12 | 100,000 | 250,000 | | 0.122 + TI*F/2,272,727.3 | | 0.166-0.232 | |
| 13 | 250,000 | 450,000 | | 0.176 + TI*F/4,444,444.4 | | 0.232-0.277 | |
| | | | | or 0.3338-25,425/TI*F | | | |
| 14 | 450000 | | | 0.396-53,550/TI*F | | 0.277-0.396 | |
| 21 | 0 | 100,000 | | 0.1 + TI*F/1,075,269 | | 0.1-0.193 | |
| 22 | 100,000 | 250,000 | | 0.155 + TI/2,631,579 | | 0.193-0.250 | |
| 23 | 250,000 | 450,000 | | 0.2025 + TI/5,263,158 | | 0.250-0.288 | |
| | | | | or 0.3364-21,656.3/TI*F | | | |
| 24 | 450000 | | | 0.396-48,600/TI*F | | 0.288-0.396 | |
| 31 | 0 | 75,000 | | 0.1 + TI*F/797,872.3 | | 0.1-0.194 | |
| 32 | 75,000 | 200,000 | | 0.1616 + TI*F/2,314,815 | | 0.194-0.248 | |
| 33 | 200,000 | 400,000 | | 0.207 + TI*F/4,878,049 | | 0.248-0.289 | |
| | | | | or 0.33-16,400/TI | | | |
| 34 | 400000 | | | 0.396-42,800/TI*F | | 0.289-0.396 | |
| 41 | 0 | 50,000 | | 0.1 + TI*F/757,575.8 | | 0.1-0.166 | |
| 42 | 50,000 | 125,000 | | 0.122 + TI/1,136,363.6 | | 0.166-0.232 | |
| 43 | 125,000 | 225,000 | | 0.176 + TI/2,222,222.2 | | 0.232-0.277 | |
| | | | | 0.3338-12,712.5/TI | | | |
| 44 | 225,000 | | | 0.396-26,775/TI | | 0.277-0.396 | |

TABLE 5
Comparison between existing federal and
LG tax rates for Married Joint
(After reducing 7 taxable income ranges to 4
and simplifying taxable income ranges)

| Taxable income | Existing tax rates | LG tax rates | Tax rate difference |
|---|---|---|---|
| 5.1 | 10-19.6% | 10.0% | −9.6% |
| 50.1 | 10-12.0% | 10.0% | −2.0% |
| 1,001 | 10.1% | 10.1% | 0.0% |
| 20,000 | 10.4% | 11.3% | 0.9% |
| 70,000 | 13.7% | 14.6% | 0.9% |
| 100,000 | 16.6% | 16.6% | 0.0% |
| 200,000 | 21.6% | 21.0% | 0.6% |
| 400,000 | 26.9% | 27.0% | 0.1% |
| 1,000,000 | 34.2% | 34.3% | −0.1% |
| 5,000,000 | 38.5% | 38.5% | 0.0% |
| 10,000,000 | 39.3% | 39.3% | 0.0% |

A tax payroll computer program product has been designed according to the LG tax rate system for employers to pay employees. Federal income taxes are calculated according to the LG tax rate system (Table 4) with the tax processor, which is involved into the tax payroll computer program product. The standard deduction for Married filing jointly, Head of household, Single or Married filing separately is $12,600, $9,250 and 6,300 in 2015 (or $12,600, $9,300 or $6,300 in 2016) respectively. Personal exemption is $4,000 each in 2015 (or $4,050 in 2016). For daily (not common), weekly, bi-weekly, semi-monthly, monthly, quarterly, semi-annual or annual basis, filing period factor (F), which is 365, 52, 26, 24, 12, 4, 4, 2 or 1, is designed into the tax rate formulas in Table 4. For example, when a Single has bi-weekly taxable income $2,050.02, its yearly taxable income is $53,300.52 by 2,050.02*26, which is used for calculating tax rate 16.68% with the tax rate formula 3/1 of (0.1+2,050.02*26/797,872.3) and income tax $341.95 on the bi-weekly basis. The standard deduction and exemption for the bi-weekly basis are to $242.31 (6300/26) and $153.85 (4000/26) in 2015. The filing period factor is 26. When an actual yearly taxable income is $60,030.97 with a bonus, related tax rate is 17.52% and income tax $10,519.76 on the annual basis. Tax rates may be adjusted at different filing period of time. Yearly last withholding income taxes may be adjusted by employees' adjustments to have such as minor interests with tax differences less than $200 or $100. Annual tax returns, payroll and withholding reports are based on annual basis (F=1).

Currently, withholding tax systems from the U.S. federal and many states consider different filing periods of time of weekly, bi-weekly, semi-monthly, monthly, quarterly, semi-annual or annual basis and have complex withholding tax tables such as Kansas has 22-page tax withholding tables and the IRS has complex withholding tax tables with more than 40 pages with many numbers based on the different tax filing statuses and filing period of weekly, bi-weekly, semi-monthly, monthly or quarterly basis. Tax withholding tables from governments can be simplified by related filing period factor of 52, 26, 24, 12, 4, 4, 2 or 1 on weekly, bi-weekly, semi-monthly, monthly, quarterly, semi-annual or annual basis. Tax withholding reports are based on annual basis (F=1), which are reported to governments and individuals.

Besides the above federal and state income taxes, social security and Medicare taxes based on a social security wage (income) are also deducted from social security wage. Payroll payments are paid to employees after deducting income taxes, social security and Medicare taxes, medical insurance payments, retirements and others. The social security and Medicare tax rates are very simple at 6.2% and 1.45% respectively with a maximum wage. Both employers and employees have equal responsibilities. Withholding taxes are all income taxes plus double social security and Medicare tax rates at 2*6.2% and 2*1.45% of social security wages. A tax withholding software product has been designed, which may be combined with related payroll software product together. The payroll and withholding systems may be also involved into an accounting software product. Payroll payments and withholding taxes are needed from employers to employees, federal and state governments. Annual tax withholding reports with different tax data may be linked with payroll payments and withholding tax data directly and automatically, which are reported to governments quickly as soon finishing the last payroll payment for a year.

Current tax audits are based on random basis currently. It is reported about 1% federal tax returns are audited. How to inspect is a significant challenge. Reducing potential tax fraud crimes is another significant challenge. One is to inspect tax returns. Another is to find differences between tax returns and withholding reports by certain standards. With the LG tax rate system, governments can receive tax withholding reports (about tax data information such as social security numbers, filing statuses, AGI, income taxes, tax rates, exemptions, deductions, retirements, credits, taxable incomes, names, address and tax return option) from employers by January 15 or 31. When the IRS receives tax returns, tax data differences such as tax, tax rate, taxable income, AGI, numbers or combination can be compared between tax withholding reports from employers and tax returns from employees. For example, when income tax differences are at a high level such as more than $3,000, tax rate differences are more than 20%, or taxable income differences are more than $30,000, those tax returns need detail audits. When tax differences are at a mid level such as $2,000-$3,000, tax rate differences are 15%-20%, or taxable income (or wage) differences are $20,000-$30,000, these tax returns may need regular inspections.

When their tax differences are less than $2,000, tax rate differences are less than 15%, or taxable income differences are less than $20,000, tax refunds could be processed quickly as possible within such as one and half months. With related government tax regulations about detail audits, regular inspections and releasing tax refunds quickly at different levels, there will be more accurate tax audits and less tax fraud crimes. Related differences depend on actual situations on federal and state levels.

Many states have similar marginal tax systems. Taxes are calculated by the progressive method with more procedures and complex computer software products. The situations can be simplified similarly as federal tax systems such as to simplify existing Missouri or

Iowa tax system with 10 or 9 tax brackets to 2 or 3 tax rate ranges with 50-80% reduction. State tax systems may have different tax differences regulated comparing with the federal tax systems. For example, when income tax differences are at a high level such as more than $2,000, tax rate differences are more than 20%, or taxable income (or wage) differences are more than $40,000, those tax returns need to be audited. When tax differences are at a mid level such as $1,500-$2,000, tax rate differences are 15%-20%, or taxable income differences are $30,000-$40,000, these tax returns may need regular inspections. When tax differences are less than $1,500, tax rate differences are less than 15%, or taxable income (or wage) differences are less than $30,000, related tax refunds would be processed within such as 45 days. Many taxpayers use standard deductions as non-complex tax situations such as Kansas has about 80% tax returns with their standard deductions. With related government tax regulations about tax audits, inspections and releasing tax refunds at different levels, there will be more accurate tax audits and less possible tax fraud crimes. Related differences and levels (tow low/high or three low/mid/high) depend on actual situations. Also if there are tax information differences such as social security number, name, tax filing status (number), exemptions, address and retirement changes, those tax returns may be delayed to process because of those changes by taxpayers. Also tax data may be accumulated for tax analysis and projection with related software products. Many other countries also use similar marginal tax systems, which can be simplified with the LG tax rate system with the tax processor. Related computer programs or software products, which may or may not involve the tax processor, can be designed with the LG tax rate system to reduce tax brackets, tax returns and potential tax fraud crimes and save tax processing time and costs.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### Example 1

A man has Married filing jointly (1) status. His annual wage is $126,505.87 from his employer. He has two children, in which one child has federal tax credit $1,000. He, his wife and children live in California with one-source income. His wife is a homemaker. His federal standard deductions are $12,600 for Married Filing Jointly, $4,000 for each personal exemption and $1,000 for one child credit. His state has standard deductions of $8,088 and exemption credit of $218 for Married Filing Jointly and dependent exemption credit of $337. After his wage, retirement and tax data are inputted, the designed payroll-withholding computer program product with the LG tax processor shows his bi-weekly payroll payment is $3,560.68 with his bi-weekly federal withholding income tax $514.20 at tax rate 15.95% and bi-weekly state income tax $118.51 at tax rate 4.13%. The payroll-withholding program also shows withholding taxes including income tax and social security and Medicare taxes from both employee and employer are $1,258.64. The social security and Medicare taxes from his employer are $372.22.

By the end of the year, if he receives a bonus $4,500, which is adjusted by the tax computer program, his last payroll payment is $6,451.40 with the federal income tax $1,512.79 and state income tax $384.95. His yearly federal tax rate is at 16.24% and state tax rate is at 4.24%. In 2015, he pays his federal income tax $14,367.77 and state income tax $4,231.28. The computer program also shows the total withholding taxes including all yearly income taxes and social security and Medicare taxes from both employee and employer are $34,411.66, which needs to be transferred to the Internal Revenue Service, and the total state withholding income $4,231.28 is be transferred to his state. When existing federal and state withholding tax systems are used, related withholding tables and formulas on weekly, bi-weekly, semi-monthly, monthly, quarterly, semi-yearly or yearly basis, which are complex and take time for each employee at each filing period, are used to estimate income taxes. The estimated taxes require all employees to file tax returns to correct prior estimations by employers and figure out exact income taxes.

The IRS may have his 2015 tax withholding report with tax data: name (John Smith), social security number (123456789), social security wage ($131,005.87), filing status (1/MFJ), exemptions (4), retirement ($7,800), taxable income ($94,605.87), tax rate (16.24%), income tax ($15,367.77), tax credit ($1,000), social security tax ($8,122.36), Medicare tax ($1,899.59), withholding income tax ($14,367.77), address (12345 A St, San Francisco, Calif. 98765) and tax return filing option (1/No with such as interests and tax difference less than $200 or $100) as his tax data records when his employer files his withholding report to the IRS by January 15 or 31. Some necessary modifications with minor changes may be filed to the IRS by January 31 or February 15. When the federal and state governments receive his withholding report and tax return, the above tax data can be compared for inspection purpose. Then a decision for audit, regular inspection, quick tax refund or tax return filing option may be made. Besides his wage from his company, his family has total bank interest $450.53 in 2015, which is reported to the IRS by his bank.

When he prepares his federal tax return with his wage, interest and tax information, the tax return software program designed by our software engineers with the LG tax rate system is used, which shows his owe tax is $92.39 because he adds the bank interest ($450.53) into his income. His owe tax $92.39 can be also obtained by the IRS with the tax return software program. The estimated average taxpayer burden for Form 1040 is about $260 according to the IRS report in Form 1041 Instruction (2014). $92.39 is less than $260, which can not cover the average cost. It is not worth for his family to file tax return and for the IRS to process his tax return to cover $92.39. He may adjust his interest and let the IRS to know he would not file his tax return through his employer. The IRS may let taxpayers with tax differences less than such as $200 and taxable income less than $100,000 (or AGI less than $120,000) to have option to not file tax returns. Federal and state governments may offer taxpayers, who meet certain qualifications, have the option to not file tax returns. Then significant tax returns numbers could be reduced for saving time and costs from this option for governments, companies and individuals.

### Example 2

A woman has the filing status of Head of Household with two children in their element and mid schools. Her wage rate is at $35/hour from her employer. Her two children have federal tax credit $1,000*2. She and her children live in Kansas with one-source income. Her federal standard deductions are $9,250 for Head of Household, $4,000 for each personal exemption and tax credits $2,000 for her two children. Her state has standard deductions of $5,500 and personal exemption at $2,250 for each. After her tax data are inputted with the first bi-weekly work for 82.18 hours, the designed payroll-withholding computer software product by our software engineers with the LG tax rate system shows her bi-weekly payroll payment is $2,249.42 with her bi-weekly federal withholding income tax $211.77 at tax rate 14.74% and bi-weekly state income tax $95.08 at tax rate 4.12%. The payroll-withholding software program also shows withholding taxes including income tax and social security and Medicare taxes from both employee and employer are $651.84. The social security and Medicare taxes from her employer are $220.04

By the end of June, her total working time is 1,050.25 hours, then her federal tax rate is at 14.62%, total federal income tax from January to June is $3,630.46 and withholding income tax is $2,630.46 after deducting the tax credit $1,000. Her state tax rate is at 4.11%, total state income tax from January to June is $1,206.85. By the end of the year, her total working time is 2,150.25 hours plus a bonus $2,500, then her tax rate is at 15.01%, total federal income tax in 2015 is $8,093.60 and withholding income tax is $6,093.60 after deducting the tax credit $2,000. Her state tax rate is at 4.15% and total state income tax in 2015 is $2,608.80. Her last bi-weekly payroll payment is $3,789.39 with her last bi-weekly federal withholding income tax $921.89.06 and last bi-weekly state income tax $261.05.

The computer program product shows the total withholding taxes including yearly income taxes and social security and Medicare taxes from both employee and employer are $17,990.69, which is transferred to the IRS and the total state withholding income tax $2,608.80 is be transferred to her state. Social security and Medicare taxes from her employer are $5,948.54. When existing federal and state withholding tax systems are used, related withholding tables and formulas on weekly, bi-weekly, semi-monthly, monthly, quarterly, semi-yearly or yearly basis, which are complex and take time for each employee at each filing period, are used to estimate income taxes. The estimated taxes require all employees to file tax returns to correct prior estimations.

The IRS can have her 2015 tax data information such as name (Jane Johnson), social security number (567656789), social security wage ($77,758.75), filing status (2 or HH), exemptions (3), retirement ($2,600), taxable income ($53,908.75), tax rate (15.01%), federal income tax ($8,093.60), tax credit ($2,000), social security tax ($4,568.39), Medicare tax ($1,068.41), withholding income tax ($6,093.60) and address (34567 A Street, Lenexa, Kans. 34567) as her tax data records when her employer files her withholding report to the IRS by January 31. Some necessary modifications with minor changes may be filed to the IRS by February 15. Also her state has her 2015 state income tax $2,608.80, filing status (2 or HH), exemptions (3) and state taxable income ($62,908.75), tax rate (4.15%) and federal adjustable gross income AGI ($75,158.75). When the federal and state governments receive her withholding report and tax return, the above tax data information can be compared for inspection purpose. Then a decision for audit, regular inspection, immediate refund or tax return option may be made. Kansas or a government may offer taxpayers a simple online software product to calculate their state income taxes according to social security numbers and federal AGI without changes of filing status, exemption and state standard deductions. Kansas has about 80% tax returns with simple standard deductions. When their state tax differences are less than $100, they have the option to not file state tax returns and let their state government to know their option.

Besides her wage from her company, she has total bank interest $1,265.25 and capital gain $2,234.75 and deposits an IRA $3,000 in 2015. When she prepares her tax return with her wage, interest, capital gain, IRA and tax information, our federal tax return software program designed by our software engineers shows her owe tax is $106.29 because of adding the bank interest and capital gain and deducts IRA, which are also reported to the IRS by her bank and investment company. Also our state tax return software program shows her owe tax is $23.00 because of adding the bank interest and capital gain and deducts IRA, which are also reported to her state by her bank and investment company. $106.29 is less than $200 or $23.00 is less than $100, which can not cover the basic federal or state tax processing cost. It is not worth for her to file federal and state tax returns and for the IRS and her state to cover the costs. She or her employer may let the IRS to know she would not file her tax return. Her owe taxes $106.29 and $23.00 can be also obtained by the IRS or her state with the tax return software product. Federal and state governments may offer taxpayers with low level tax differences to have the option to not file tax returns. Then significant tax returns numbers could be reduced for saving time and costs from this option for taxpayers and governments.

### Example 3

Many other countries also use some marginal tax systems with multi tax brackets for their income tax systems. Multi tax brackets are needed for smooth tax rate changes. More tax brackets mean more smooth tax rate changes, which are more reasonable for different taxable incomes. But more tax brackets involve more tax processing time and costs. Less tax brackets mean non-smooth tax rate changes with a flat and marginal tax system. Table 6 shows the tax rates for Australian residents in 2015-2016. There are 5 flat tax rates of 0, 19%, 27%, 32.5% and 45% during the 5 tax brackets. The graph between taxable incomes and tax rates from Table 6 is not smooth with steps and rough curves with changeable tax rate change slopes. The number $54,547 is from 0.19*(37,000−18,200)+0.325*(80,000-37,000)+0.37*(180,000-80,000) in Table 6, which is progressive. When the LG tax rate system is used, the tax rates can be simplified with the 3 tax brackets (40% reduction) with simple taxable income ranges and smooth tax rate changes, which are shown in Table 7. Also the 3 tax rate range checks of 0-0.1, 0.1-0.3 and 0.3-0.45 are used for checking related calculations to avoid or reduce tax rate and tax calculations. The graph between taxable incomes and tax rates from Table 7 is smooth with a constant tax rate change slope 1/220,000 and 1/700,000 during the two first taxable income ranges. The LG tax rate system may be used to design related tax software product for income tax calculation, payroll, analysis, inspection, reform or/and projection reasonably.

TABLE 6
Australian Resident Tax Rates for 2015-16 (from Jul. 1, 2015)

| Taxable Income (TI) | Tax on this income | Tax Computation |
|---|---|---|
| 0-$18,200 | Nil | 0 |
| 18,201-37,000 | 19c for each $1 over $18,200 | 0.19 * (TI − 18,200) |
| 37,001-80,000 | $3,572 plus 32.5c for each | 3,572 + 0.325 * |
| | $1 over $37,000 | (TI − 37,000) |
| 80,001-180,000 | $17,547 plus 37c for each | 17,547 + 0.37 * |
| | $1 over $80,000 | (TI − $80,000) |
| 180,001 and over | $54,547 plus 45c for each | 54,547 + 0.45 * |
| | $1 over $180,000 | (TI − 180,000) |

TABLE 7
LG Tax Rate System for Australian Resident Tax Rates for 2015-16

| Taxable income | | | (Range | Tax | |
|---|---|---|---|---|---|
| (TI) | TI | Tax rate formula | check) | rate | Tax |
| $18,000-40,000 | | TI * F/220,000 − | (0-0.1) | | |
| | | 0.082 | | | |
| $40,000-180,000 | | 0.043 + TI * | (0.1-0.3) | | |
| | | F/700,000 | | | |
| Over 180,000 | | 0.45 − 27,000/ | (0.3-0.45) | | |
| | | TI * F | | | |

Total Tax=Σ(TI²)m/220000−0.082ΣTIm+0.043ΣTin+Σ(TI²)n/700000+0.45ΣTIp−27000p (1)

### Example 4

The existing U.S. corporate tax system has the 8 tax brackets and 8 marginal tax rates, which are 15%, 25%, 34%, 39%, 34%, 35%, 38% and 35%, and is shown in Table 8. When the LG tax rate system with the tax processor is used, the 8 tax brackets are reduced to 3 tax rate ranges, which are shown in Table 9 with the two tax rate range options. There are minor tax rate differences when taxable incomes are over $60,000, which are shown in Table 8. The flat tax rate at 15% in the existing tax system is unreasonable to cover different taxable incomes from 0 to $50,000, which are shown in Table 8. A tax processor or corporate tax return program product is designed to pick up related taxable income range and tax rate formula and calculate tax rate and tax automatically according to a taxable income or income. The LG tax rate system in Table 9 makes tax analysis, reform and projection simply. For example when a company has its tax data of yearly income, cost, deduction and credit to calculate its taxable income $98,379.38, its yearly income tax is $21,725.99 at tax rate 22.08% with tax rates 12-35% in Table 9. When the existing tax computation in Table 8 is used, its yearly income tax is $21,698.99 at tax rate 22.06%. Their tax rate difference is 0.02% only (22.08%-22.06%). A tax processor or corporate withholding tax program product is designed to figure out withholding taxes to federal and state governments on monthly, quarterly and yearly basis.

Tax data such as subtotal tax for a taxable income group, total tax or average tax rate may be calculated from taxable incomes and related formulas. It is not necessary to calculate different taxes for all corporations at first and add them together each time. For such as 12-35% tax rates in Table 9, total tax is:

Total Tax=0.12ΣTIi+Σ(TI²)i/975,610+0.39ΣTij−16,750j+0.35ΣTIk−3,350k=f(TI) (2)

Here i, j and k are corporation tax filing numbers during the three taxable income ranges. The total tax equation (1) is used to calculate total taxes. Tax amount or tax rate is a function of TI (and TI²). When ΣTIi and ΣTI² are known in a certain year, then tax projection can be done according to taxable income data. For example tax rate range 12-35% in Table 9 is reformed to 10-28% in Table 11, then prior taxable income data can be used to do their tax projection by subtracting (2) from (3) into (4):

Total Tax=0.1ΣTIi+Σ(TI²)i/1,904,762+0.32ΣTij−16,750j+0.28ΣTIk−3,350k=f(TI) (3)

Tax Projection=−0.02ΣTIi+Σ(TI²)i(1/1,904,762−1/975,610)−0.07ΣTIj−0.07ΣTIk (4)

TABLE 8
Existing Federal Corporate Tax Rate Schedule

| Taxable income (TI) | | | |
|---|---|---|---|
| Over But do not over | Tax is of the amount over | | Tax computation |
| $0-$50,000 | 15% | | 0.15 * TI |
| 50,000-75,000 | $7,500 + 25% | 50,000 | 7,500 + 0.25 * (TI − 50,000) |
| 75,000-100,000 | $13,750 + 34% | 75,000 | 13,750 + 0.34 * (TI − 75,000) |
| 100,000-335,000 | $22,250 + 39% | 100,000 | 22,250 + 0.39 * (TI − 100,000) |
| 335,000-10 million | $113,900 + 34% | 335,000 | 113900 + 0.34 * (TI − 335,000) |
| 10 million-15 million | $3,400,000 + 35% | 10,000,000 | 3,400,000 + 0.35 * (TI − 10,000,000) |
| 15 million-18,3333,333 | $5,150,000 + 38% | 15,000,000 | 5,150,000 + 0.38 * (TI − 15,000,000) |
| Over 18,333,333 | 35% | | 0.35 * TI |

TABLE 9
LG Tax System for Federal Corporations

| Taxable income (TI) | | Tax rates: 15-35% | | | Tax rates: 12-35% | |
|---|---|---|---|---|---|---|
| Over | Not over | Tax rate formula | (Range check) | or | Tax rate formula | (Range check) |
| 0 | 100,000 | 0.15 + TI * F/1,379,310 | (0.15-0.2225) | | 0.12 + TI * F/975,610 | (0.12-0.2225) |
| 100,000 | 335,000 | 0.39 − 16,750/TI * F | (0.2225-0.34) | | 0.39 − 16,750/TI * F | (0.2225-0.34) |
| 335,000 | | 0.35 − 3,350/TI * F | (0.34-0.35) | | 0.35 − 3,350/TI * F | (0.34-0.35) |

TABLE 10
Comparison of Tax Rates (Existing and LG Corporate Tax Systems)

| | Existing Fed Tax | | | |
|---|---|---|---|---|
| Taxable income | (Table 8) | | LG Tax System | |
| TI ($) | Tax ($) | Tax rate | (Table 9) | Difference |
| 10,000 | 1,500 | 15% | 13.0% | −2.0% |
| 20,000 | 3,000 | 15% | 14.1% | −1.0% |
| 50,000 | 7,500 | 15% | 17.1% | 2.1% |
| 60,000 | 10,000 | 16.7% | 18.2% | 1.45% |
| 80,000 | 15,450 | 19.3% | 20.2% | 0.9% |
| 100,000 | 22,250 | 22.3% | 22.3% | −0.1% |
| 200,000 | 61,250 | 30.6% | 30.6% | 0.0% |
| 300,000 | 100,250 | 33.4% | 33.4% | 0.0% |
| 335,000 | 113,900 | 34% | 34.0% | 0.0% |
| 500,000 | 170,000 | 34% | 34.3% | 0.3% |
| 1,000,000 | 340,000 | 34% | 34.7% | 0.7% |
| 20,000,000 | 7,000,000 | 35% | 35.0% | 0.0% |

During a recession, booming economy or special situation, LG tax rates may be reduced for job stimulation and business opportunities to promote economic growth simply.

Conversely, LG tax rates may be increased for collecting more taxes. Tax reform is done by reforming tax rates to 10-30%, 10-28% or another tax rate range. Their tax brackets are 3, which are shown in Table 11. In Tables 9 and 11, the last tax bracket covers tax rate difference 1% only, which may be reformed to more average and reasonable ranges. When 3 tax brackets are used, whole tax rate range may be divided into 3 averagely to be more uniform, which is shown in Table 12. Their taxable income ranges are further simplified from 0-100,000-335,000 to 0-100,000-200,000. For tax rate range of 15-35% is reformed to 10-28%, the 8 existing tax brackets can be reduced to 2 tax rate ranges with 75% reduction, which is shown in Table 12 reasonably. For such as 10-28% tax rates in Table 12, total tax is simple. Here p and q are business tax filing numbers during the two taxable income ranges.

Total Tax=0.1ΣTIp+Σ(TI²)i/1,666,666.7+0.28ΣTIq−12,000q (5)

TABLE 11
LG Tax Rate Reform I for Federal Corporations

| Taxable Income (TI) | | Tax Rates 10-30% | | Tax Rates 10-28% | |
|---|---|---|---|---|---|
| Over | Not over | Rate formula | (Range check) | Rate formula | (Range check) |
| 0 | 100,000 | 0.1 + TI/1,379,310 | (0.1-0.1725) | 0.1 + TI/1,904,762 | (0.1-0.1525) |
| 100,000 | 335,000 | 0.34 − 16,750/TI | (0.1725-0.29) | 0.32 − 16,750/TI | (0.1525-0.27) |
| 335,000 | | 0.3 − 3,350/TI | (0.29-0.3) | 0.28 − 3,350/TI | (0.27-0.28) |

TABLE 12
LG Tax Rate Reform II for Federal Corporations

| Taxable Income (TI) | | Tax Rates 10-30% | | Tax Rates 10-28% | |
|---|---|---|---|---|---|
| Over | Not over | Rate formula | (Range check) | Rate formula | (Range check) |
| 0 | 100,000 | 0.1 + TI * F/1,428,571.4 | (0.1-0.17) | (TI: 0-200,000) | (2 tax rate ranges) |
| 100,000 | 200,000 | 0.1 + TI * F/1,250,000 | (0.17-0.25) | 0.1 + TI * F/1,666,666.7 | (0.1-0.22) |
| | | or 0.33 − 16,000/TI * F | | | |
| 200,000 | | 0.3 − 10,000/TI * F | (0.25-0.3) | 0.28 − 12,000/TI * F | (0.22-0.28) |

The two simple linear and gradual math equations of y=a+bx and y=c−d/x are used in the LG tax system, in which these constants of a, b, c and d may be modified quickly and reasonably according to actual situations. Either a+TI/b or c−d/x can be used for tax rate format. In a+TI/b, tax rates change linearly with the same slope 1/b, which are more reasonable and is suggested for tax rate formulas except last tax rate range. In c−d/x, tax rates increase fast at first and then slow down with changeable tax rate slopes at d/TI², which is suggested for last tax rate range for high taxable incomes. For the tax rate formulas in Tables 9, 11 and 12, c−d/x is used for the last tax rate range. For tax rate reform, a, b, c, d or their combination may be reformed for related purpose according to different economic condition or tax revenue adjustment to desirable levels.

### Example 5

China had 9 tax brackets (tax rates: 5-45%) in 2007, which has been reformed to 7 tax brackets with tax rates 3-45% now and is shown in Table 13. There are the 7 marginal tax rates of 3%, 10%, 20%, 25%, 30%, 35% and 45% during the 7 tax brackets on monthly basis. There is no tax filing status difference, which mean no difference between such as married filing jointly and married filing separately or single, which is unreasonable. The graph between taxable incomes and tax rates from Table 13 is not smooth with flat tax rate and rough curves with changeable tax rate change slopes. When the LG tax rate system is used, the tax rates can be simplified to the 4 tax brackets (43% reduction). Simple taxable income ranges and smooth tax rate changes are shown in Table 14. The graph between taxable incomes and tax rates from Table 14 is smooth with constant tax rate change slopes during the taxable income range 0-200,000. Also different filing periods with corresponding taxable incomes are considered by the factor F, which may be such as 1, 2, 3, 6 or 12 on monthly, bi-monthly, quarterly, semi-yearly or yearly for withholding taxes from employers to the national government.

Tax rate differences between the LG tax rate system and existing China tax system are shown in Table 15 or their graph lines with minor differences. It is good to simplify the existing 7 marginal tax rates of 3%, 10%, 20%, 25%, 30%, 35% and 45% and complex tax system into the 4 tax rate ranges with the 4 simple taxable income ranges. The LG tax rate system with the tax processor may be used to design a tax software product for income tax calculation, payroll, analysis, inspection, reform or projection reasonably. A payroll-withholding software program is designed for employers to use.

TABLE 13
Chinese Personal Tax Rates (2015) (Monthly)

| # | Taxable income/M(TI) | Tax Rate | Tax Computation |
|---|---|---|---|
| 1 | not over 1,500 | 3% | 0.03 * TI |
| 2 | 1,500-4,500 | 10% | 0.03 * 1500 + 0.1 * (TI − 1500) = 0.1 * TI − 105 |
| 3 | 4,500-9,000 | 20% | 45 + 0.1 * 3000 + 0.2 * (TI − 4500) = 0.2 * TI − 555 |
| 4 | 9,000-35,000 | 25% | 45 + 300 + 0.2 * 4500 + 0.25 * (TI − 9000) = 0.25 * TI − 1005 |
| 5 | 35,000-55,000 | 30% | 345 + 900 + 0.25 * 26000 + 0.3 * (TI − 35000) = 0.3 * TI − 2755 |
| 6 | 55,000-80,000 | 35% | 7745 + 0.3 * 20000 + 0.35 * (TI − 55000) = 0.35 * TI − 5505 |
| 7 | over 80,000 | 45% | 13745 + 0.35 * 25000 + 0.45 * (TI − 80000) = 0.45 * TI − 13505 |

TABLE 14
LG Tax Rate System for Personal Tax Rates (2015) (F: monthly factor)

| Taxable income (TI) | | | | | Tax | Tax |
|---|---|---|---|---|---|---|
| Over | Not over | TI | Tax rate formula | Range check | rate | TI * rate |
| 0 | 10,000 * F | | 0.03 + TI/F * 83333.3 | 0.03-0.15 | | |
| 10,000 * F | 50,000 * F | | 0.12625 + TI/F * 421052.6 | 0.15-0.245 | | |
| 50,000 * F | 100,000 * F | | 0.175 + TI/F * 714285.7 | 0.245-0.315 | | |
| 100,000 * F | | | 0.45 − 13500 * F/TI | 0.315-0.45 | | |

TABLE 15
Comparison of Tax Rates (Existing and LG tax systems)

| | Existing Tax System | | | |
|---|---|---|---|---|
| Taxable income | (Table 13) | | LG Tax System | |
| T1 ($) | Tax ($) | Tax rate | (Table 14) | Difference |
| 500 | 150 | 3% | 3.6% | 0.6% |
| 5,500 | 545 | 9.9% | 9.6% | −0.3% |
| 8,000 | 1,045 | 13.1% | 12.6% | 0.5% |
| 10,000 | 1,449 | 15.0% | 15.0% | 0.0% |
| 50,000 | 12,245 | 25.0% | 25.0% | 0.0% |
| 60,000 | 15,498 | 25.8% | 25.9% | 0.1% |
| 100,000 | 31,500 | 31.5% | 31.5% | 0.0% |
| 250,000 | 99,000 | 39.6% | 39.6% | 0.0% |
| 500,000 | 211,500 | 42.3% | 42.3% | 0.0% |
| 750,000 | 324,000 | 43.2% | 43.2% | 0.0% |
| 1,000,000 | 436,500 | 43.65% | 43.65% | 0.0% |
| 10,000,000 | 4,486,000 | 44.86% | 44.86% | 0.0% |
| 50,000,000 | 22,485,000 | 44.97% | 44.97% | 0.0% |

There are the 4 tax filing statues in the existing U.S. federal personal tax systems, which are more reasonable because each status has difference economical responses. The existing U.S. federal Tax Rate Schedules and Tax Table/Tax Computation Worksheet are yearly based, which are then converted to such as bi-weekly, semi-monthly, monthly, quarterly and semi-yearly related tables and formulas for employers to estimate withholding taxes and for employees to calculate income taxes for filing tax returns. Existing China tax system, which is monthly based, has no tax filing status difference. We suggest the fair 3 tax filing statuses of married filing jointly, single or married filing separately, married filing jointly and head of household, which may be replaced existing China tax system. When annual basis is used, filing period factor is 12 (12 months). Table 16 shows the LG tax rate system to cover the three tax filing status, less tax brackets, filing period and tax rate range check reasonably. The tax rate formulas of a+x/b and c−d/x are based on taxable income ranges and tax rate ranges. The differences between single/married filing separately and married filing jointly or head of household are 200% or 150% for taxable incomes and tax rate formulas respectively. A tax return software product is designed for employees to use. Related tax software products for tax analysis, inspection, reform and projection may be designed reasonably.

TABLE 16
LG Tax Rate System for Chinese Personal Tax Rates
(F: monthly factor) (1) Single or Married Filing Separately, (2)
Married Filing Jointly or widow(er) or (3) Head of Household

| Filing | Taxable income (TI) | | | | Tax rate | Tax | Tax |
|---|---|---|---|---|---|---|---|
| status | Over | Not over | TI | Tax rate formula | Range check | rate | TI*rate |
| 11 | 0 | 10,000*F | | 0.03 + TI/F*83,333.3 | 0.03-0.15 | | |
| 12 | 10,000*F | 50,000*F | | 0.12625 + TI/F*421,052.6 | 0.15-0.245 | | |
| 13 | 50,000*F | 100,000*F | | 0.175 + TI/F*714,285.7 | 0.245-0.315 | | |
| 14 | 100,000*F | | | 0.45-13,500*F/TI | 0.315-0.45 | | |
| 21 | 0 | 20,000*F | | 0.03 + TI/F*166,666.6 | 0.03-0.15 | | |
| 22 | 20,000*F | 100,000*F | | 0.12625 + TI/F*842,105.2 | 0.15-0.245 | | |
| 23 | 100,000*F | 200,000*F | | 0.175 + TI/F*1,428,571.4 | 0.245-0.315 | | |
| 24 | 200,000*F | | | 0.45-27,000*F/TI | 0.315-0.45 | | |
| 31 | 0 | 15,000*F | | 0.03 + TI/F*124,500 | 0.03-0.15 | | |
| 32 | 15,000*F | 75,000*F | | 0.12625 + TI/F*631,579 | 0.15-0.245 | | |
| 33 | 75,000*F | 150,000*F | | 0.175 + TI/F*1,071,428.6 | 0.245-0.315 | | |
| 34 | 150,000*F | | | 0.45-20,250*F/TI | 0.315-0.45 | | |

### Example 6

The State of Missouri has the existing personal tax system with the 10 tax brackets and 10 marginal tax rates, which are 1.5%, 2%, 2.5%, 3%, 3.5%, 4%, 4.5%, 5%, 5.5% and 6% and related tax tables for tax withholding and tax returns. Table 17 shows the existing Missouri Tax Chart for individuals. When the LG tax rate system with the tax processor is used, the 10 tax brackets are reduced to 2 tax rate ranges with 80% reduction, which are much simple and shown in Table 18. The taxable income $10,000 in Table 18 is easier than $9,000 in Table 17. We have designed a software product for Missouri tax returns by the LG tax rate system with the tax processor. When federal adjustable gross income (AGI), deduction, exemption, credit and tax withholding are inputted, income tax is figured out automatically. The tax rate differences between existing Missouri Tax Chart and LG tax rate system are extremely minor, which are shown in Table 19. When MO income tax differences are less than $100 or $50 between tax withholding and tax returns, these taxpayers may have the option to not file tax returns, which can reduce tax return numbers for reducing tax processing time and costs.

TABLE 17
Existing Missouri Tax Chart

| If the Missouri | |
|---|---|
| taxable income is: | The tax is: |
| $0 to $99 | $0 |
| At least $100 but not over | 1½% of the Missouri taxable income |
| $1,000 | |
| Over $1,000 but not over $2,000 | $15 plus 2% of excess over $1,000 |
| Over $2,000 but not over $3,000 | $35 plus 2½% of excess over $2,000 |
| Over $3,000 but not over $4,000 | $60 plus 3% of excess over $3,000 |
| Over $4,000 but not over $5,000 | $90 plus 3½% of excess over $4,000 |
| Over $5,000 but not over $6,000 | $125 plus 4% of excess over $5,000 |
| Over $6,000 but not over $7,000 | $165 plus 4½% of excess over $6,000 |
| Over $7,000 but not over $8,000 | $210 plus 5% of excess over $7,000 |
| Over $8,000 but not over $9,000 | $260 plus 5½% of excess over $8,000 |
| Over $9,000 | $315 plus 6% of excess over $9,000 |

TABLE 18
LG Tax Rate System for MO Individuals

| Filing | Taxable income (TI) | | Your | | Tax | Tax rate | Tax |
|---|---|---|---|---|---|---|---|
| Status | Over | Not over | TI | Tax rate formula | rate | range check | Rate*TI |
| 1 | 0 | 10,000 | | 0.01313 + TI*F/410,256.4 | | 0.013-0.0375 | |
| 2 | 10,000 | | | 0.06-225/TI | | 0.0375-0.06 | |

With the LG tax rate system, tax withholding, tax return, analysis, reform and projection become much easy to do. It is not necessary to calculate different taxes for all individuals at first and add them together each time. Filing period factor (such as F=26, 24 or 12 on bi-weekly, semi-monthly or monthly basis) is used for tax withholding. Total tax is a simple function of taxable incomes.

Total Tax=0.01313ΣTIm+(TI)²m/410,256.4+0.06ΣTIn−225*n (6)

Here m and n are taxpayer numbers during the two taxable income ranges. When the existing tax chart (computations) and tax table are used, tax calculation, tax analysis, reform and projection are difficult and complex to do with more time and cost. 0.0375 may be reformed to 0.37 or 1.313% may be reformed to 1.3% or 1.5%.

TABLE 19
Comparison of Tax Rates (Existing MO and LG tax rate systems)

| Taxable income | Existing Tax System | LG Tax System | |
|---|---|---|---|
| T1 ($) | (Table 17) | (Table 18) | Difference |
| 500 | 1.60% | 1.43% | −0.17% |
| 2,000 | 1.80% | 1.80% | 0.00% |
| 4,000 | 2.30% | 2.29% | −0.01% |
| 5,000 | 2.54% | 2.53% | −0.01% |
| 6,000 | 2.78% | 2.78% | 0.00% |
| 7,000 | 3.04% | 3.02% | −0.02% |
| 8,000 | 3.28% | 3.26% | −0.02% |
| 9,000 | 3.50% | 3.51% | 0.01% |
| 10,000 | 3.75% | 3.75% | 0.00% |
| 100,000 | 5.78% | 5.78% | 0.00% |
| 20,000,000 | 6.00% | 6.00% | 0.00% |

What is claimed is:

1. A linear and gradual tax rate system comprising a tax processor for a tax software product to figure out income taxes according to tax information and the software product is used for a tax return system by taxpayers, for a payroll and tax withholding system by employers or for tax inspection system by governments.

2. The linear and gradual tax rate system comprising the tax processor of claim 1 wherein the linear and gradual tax rate system comprising two or more taxable income ranges with preferred from 2 to 5 taxable income ranges, related tax rate ranges, filing period factor (F), tax rate formulas of a+TI*F/b or c−d/TI*F (a, b, c and d are constants, TI is taxable income and F is filing period factor) and the tax processor to figure out tax rate and income tax according to a taxable income.

3. The linear and gradual tax rate system comprising the tax processor of claim 1 wherein the tax rate formula of a+TI*F/b or c−d/TI*F is based on taxable income ranges and related tax rate ranges to find related constants of a, b, c and d to cover related taxable income ranges and tax rate ranges.

4. The linear and gradual tax rate system comprising the tax processor of claim 1 wherein taxpayers are individuals or businesses with one or more tax filing statuses to use the tax processor or tax software product to figure out income taxes for tax returns or preparing tax returns.

5. The linear and gradual tax rate system comprising the tax processor for a tax software product of claim 1 wherein employers use the tax software product to figure out income taxes, payroll payments and withholding taxes for employers, employees and governments.

6. The linear and gradual tax rate system comprising the tax processor for the tax software product of claim 5 wherein the software product for payroll system or withholding tax system is independent or combined together.

7. The linear and gradual tax rate system comprising the tax processor for the tax software product of claim 5 wherein withholding taxes are figured out according to different filing period number of weekly, bi-weekly, semi-monthly, monthly, quarterly, semi-annual or annual basis with filing period factor (F) 52, 26, 24, 12, 4, 2 or 1.

8. The linear and gradual tax rate system comprising the tax processor for the tax software product of claim 5 wherein annual tax withholding reports with tax filing status, deduction, exemption, adjustable gross income, taxable income, tax, tax rate, credit, withholding tax, payroll and tax data, besides existing name, social security number, social security income, social security tax, Medicare tax, address and retirement, federal tax and state tax from W-2 Form, are reported automatically or manually from employers to governments and employees.

9. The linear and gradual tax rate system comprising the tax processor for the tax software product of claim 1 wherein governments use the software product to inspect tax returns from taxpayers by comparing tax withholding reports from employers with two or more levels of income tax differences for detail audit, regular inspection, quick tax refund or tax return filing option.

10. The linear and gradual tax rate system comprising the tax processor for the tax software product of claim 9 wherein income tax differences between tax returns and tax withholding reports are at a high level to for governments to audit tax returns and a low level for taxpayers to have an option to not file tax returns.

11. The linear and gradual tax rate system comprising the tax processor of claim 1 wherein the tax processor is used to figure out income taxes independently or combined into a tax software product for tax function.

12. The linear and gradual tax rate system comprising the tax processor for the tax software product of claim 1 wherein governments use the software product to inspect tax data differences between tax withholding reports and tax returns according to one or more items of income tax, taxable income, tax rate, exemption, filing status, social security number, withholding tax and credit.

13. A tax processor in the linear and gradual tax rate system comprising inputting a taxable income or income, tax filing status and filing period factor (F) and then figuring out its income tax through the tax processor with tax rate formulas of a+TI*F/b and c−d/TI*F (a, b, c and d are constants, TI is taxable income and F is filing period factor).

14. The tax processor in the linear and gradual tax rate system of claim 13 wherein the tax processor including two or more taxable income ranges with preferred from 2 to 5 taxable income ranges, filing period factor (F), tax rate formulas of a+TI*F/b and c−d/TI*F (a, b, c and d are constants, TI is taxable income and F is filing period factor), related tax rate ranges and tax process to figure out income tax according to a taxable income.

15. The tax processor in the linear and gradual tax rate system of claim 13 wherein the filing period factor (F) is 52, 26, 24, 12, 4, 4, 2 or 1 on weekly, bi-weekly, semi-monthly, monthly, quarterly, semi-annual or annual basis.

16. The tax processor in the linear and gradual tax rate system of claim 13 wherein the filing period factor on weekly, bi-weekly, semi-monthly, monthly, quarterly, semi-annual or annual basis and the linear and gradual tax rate formulas of a+TI*F/b and c−d/TI*F (a, b, c and d are constants, TI is taxable income and F is filing period factor) are used to replace existing tax withholding tables with multi pages based on different filing period basis and different tax filing statuses for employers to estimate income withholding taxes for employees.

17. The tax processor in the linear and gradual tax rate system of claim 13 wherein existing annual tax tables for tax returns based on different taxable incomes and tax filing statuses from marginal tax systems are replaced by one or more linear tax rate formulas of a+TI/b (a and b are constants, TI is taxable income and F is 1 for annual basis) and the tax processor.

18. The tax processor in the linear and gradual tax rate system of claim 13 wherein the linear and gradual tax rate system with the tax processor is used manually or automatically.

19. The tax processor in the linear and gradual tax rate system of claim 13 wherein taxable income is from income after considering deduction, retirement, exemption, education, credit and items according to government regulations.

20. The tax processor in the linear and gradual tax rate system of claim 13 wherein the tax processor is independent or combined into a tax or accounting software product.
